(19) United States
(12) Patent Application Publication
(10) Pub. No.: US 2013/0160069 A1
(43) Pub. Date: Jun. 20, 2013

(54) APPARATUS AND METHOD FOR BONDING BROADCAST CHANNEL

(71) Applicant: Electronics and Telecommunications Research Institute, Daejeon (KR)

(72) Inventors: Woong Shik YOU, Gyeryong-si Chungcheongnam-do (KR); Dong Joon CHOI, Daejeon (KR); Nam Ho HUR, Daejeon (KR)

(73) Assignee: Electronics and Telecommunications Research Institute, Daejeon (KR)

(21) Appl. No.: 13/715,574

(22) Filed: Dec. 14, 2012

(30) Foreign Application Priority Data
Dec. 16, 2011 (KR) 10-2011-0136163

(51) Int. Cl. H04N 21/61

(52) U.S. Cl. CPC H04N 21/61
USPC 725/126

(57) ABSTRACT

An apparatus for bonding a broadcast channel, including an encoder to output at least one broadcasting program in a form of a transport stream (TS) packet by encoding the at least one broadcasting program, a multiplexer to multiplex the TS packets by mixing the TS packets with signaling information, and a transmitter to transmit the multiplexed TS packet by distributing the multiplexed TS packet via bonded channels, and the transmitter transmits control packets to control the TS packets along with the TS packets through the bonded channels via which the TS packets is transmitted is provided.

### CROSS-REFERENCE TO RELATED APPLICATION

This application claims the priority benefit of Korean Patent Application No. 10-2011-0136163, filed on Dec. 16, 2011, in the Korean Intellectual Property Office, the disclosure of which is incorporated herein by reference.

### BACKGROUND

1. Field of the Invention

The present invention relates to a method and apparatus for transmitting a mass broadcasting program through bonding of a broadcast channel.

2. Description of the Related Art

In recent years, with the distribution of a digital broadcasting providing a high definition television (HDTV) and a three-dimensional television (3DTV), conducting research into a technology of a multi-view 3DTV service and an ultra high definition television (UHDTV) service is garnering increased attention.

While the HDTV service and a binocular 3DTV service may be provided using a single broadcast channel, transmitting and providing the multi-view 3DTV service or the UHDTV service through a single broadcast channel are unfeasible at present through use of a current encoding technology.

Since a limit exists with regard to an amount of content that is transmittable by a current national terrestrial TV channel and a cable channel, transmission of multi-view 3D content captured from various points of view or UHDTV contents having an 8K*4K resolution is correspondingly limited.

Accordingly, transmission of mass broadcasting content may be achieved by expanding a usable frequency band or enhancing transmission efficiency per unit frequency.

However, since such methods fail to provide compatibility with existing transmission standards, there is a need for alternative techniques through which novel technologies may be applied.

Another method of transmitting the mass broadcasting program is to apply a new encoding technology that may increase encoding efficiency with respect to audio/video (AV) data.

That is, by applying the encoding technology in a far more efficient manner than a current encoding technology and thus, reducing an amount of data to be transmitted, the mass broadcasting content may be transmitted while using an identical transmission band.

However, in order to apply such an efficient encoding technology, since an existing encoder and decoder are unavailable due to a compatibility issue, the alternative techniques are still required.

Accordingly, a method of transmitting the mass broadcasting contents while maintaining compatibility with an existing device and a transmission infrastructure is commanding attention.

### SUMMARY

According to an aspect of the present invention, there is provided an apparatus for bonding a broadcast channel, the apparatus including: an encoder to output at least one broadcasting program by encoding the at least one broadcasting program to a transport stream packet (TS packet), a multiplexer to multiplex the TS packets by mixing the TS packets with signaling information, and a transmitter to transmit the multiplexed TS packet via bonded channels, wherein the transmitter transmits control packets, along with the TS packets, comprising information associated with the TS packets transmission through the bonded channels via which the TS packets is transmitted.

The transmitter may include a channel distributer to determine a number of channels and a transmission channel via which the TS packets is transmitted, based on an amount of data transmitted.

The control packets may include information associated with the TS packets that is transmitted via each of the determined number of channels and the transmission channel.

The information associated with the TS packets may include a number of TS packets, and the number of TS packets may include a number of packets associated with the control packets.

The information associated with the TS packets may include virtual packet sequence information, and the virtual packet sequence information comprises a packet sequence number that is tagged virtually, in a form of a single stream, with respect to the TS packets.

The control packets may be provided in a structure identical to a structure of the TS packets, and assign a packet identifier (PID) value to control the TS packets.

The multiplexer may assign the virtual packet sequence information to the encoded TS packet.

The apparatus for bonding the broadcast channel may further include a modulator to modulate and transmit the TS packets and the control packets that are transmitted to correspond to a form of a receiving terminal.

According to another aspect of the present invention, there is provided an apparatus for bonding a broadcast channel, the apparatus including: a receiver to receive TS packets and control packets comprising information associated with the TS packets transmitted via bonded channels, and rearrange the TS packets to a single stream using the control packets, and a decoder to decode the TS packets.

According to still another aspect of the present invention, there is provided a method of bonding a broadcast channel, the method including: outputting at least one broadcasting program by encoding the at least one broadcasting program to TS packets, multiplexing the TS packets by mixing the TS packets with signaling information, transmitting the multiplexed TS packet by distributing the multiplexed TS packet via bonded channels, and transmitting control packets, along with the TS packets, comprising information associated with the TS packets through the bonded channels via which the TS packets is transmitted.

According to yet another aspect of the present invention, there is provided a method of bonding a broadcast channel, the method including: receiving TS packets and control packets to control the TS packets via bonded channels, rearranging the TS packets to a single stream using the control packets, and decoding the TS packets.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a transmitting terminal of an apparatus for bonding a broadcast channel according to an embodiment of the present invention;

FIG. 2 is a block diagram illustrating a configuration of a receiving terminal of an apparatus for bonding a broadcast channel according to an embodiment of the present invention;

FIG. 3 is a block diagram illustrating an overall configuration of an apparatus for bonding a broadcast channel according to an embodiment of the present invention;

FIG. 4 is a diagram describing an example of a transmission of broadcasting content according to an embodiment of the present invention;

FIG. 5 is a diagram illustrating a structure of control packets according to an embodiment of the present invention;

FIG. 6 is a diagram illustrating an operational process of transmitting and receiving using control packets according to an embodiment of the present invention;

FIG. 7 is a flowchart illustrating a method of bonding a broadcast channel, from a perspective of a transmitting terminal of an apparatus for bonding a broadcast channel, according to an embodiment of the present invention;

FIG. 8 is a flowchart illustrating method of bonding a broadcast channel, from a perspective of a receiving terminal of an apparatus for bonding a broadcast channel, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined that a detailed description related to a related known function or configuration which may make the purpose of the present invention unnecessarily ambiguous in the description of the present invention, such detailed description will be omitted. Also, terminologies used herein are defined to appropriately describe the exemplary embodiments of the present invention and thus may be changed depending on a user, the intent of an operator, or a custom. Accordingly, the terminologies must be defined based on the following overall description of this specification.

An apparatus for bonding broadcast channels according to an embodiment of the present invention may transmit mass broadcasting content such as a multi-view three-dimensional television (3DTV) and an ultra high definition television (UHDTV) through bonding of the broadcast channels.

The apparatus for bonding the broadcast channels may provide, in bonding each of the broadcast channels, a method of transmitting the mass broadcast content through a variety of methods, for example, a method of using a specific field of a transmission packet.

The apparatus for bonding the broadcast channels may provide a method of using control packets in order to determine which packet is lost when a loss of the TS packets occurs during transmission process of broadcasting contents and for facilitating rearrangement of the TS packets in a receiving terminal.

The apparatus for bonding the broadcast channels may be applied to Advanced Television Systems Committee (ATSC) broadcasting standards, that is, not only domestic but also North American digital terrestrial standards, and to digital cable broadcasting standards of Open Cable.

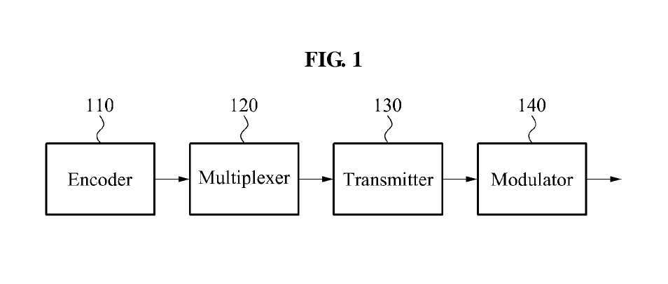

FIG. 1 is a block diagram illustrating a configuration of a transmission terminal of an apparatus for bonding a broadcast channel according to an embodiment of the present invention.

Referring to FIG. 1, the transmission terminal of the apparatus for bonding the broadcast channel may include an encoder 110 to output at least one broadcasting program in a form of a transport stream packet (TS packet) by encoding the at least one broadcasting program, a multiplexer 120 to multiplex the TS packets by mixing the TS packets with signaling information, and a transmitter 130 to transmit the multiplexed TS packet by distributing the multiplexed TS packet via bonded channels. The transmitter 130 may transmit control packets including information association along with the TS packets through the bonded channels via which the TS packets is transmitted.

The transmission terminal of the apparatus for bonding the broadcast channel according to an aspect of the present invention may modulate and transmit the TS packets and the control packets that are transmitted to correspond to a format of a reception terminal using a modulator 140.

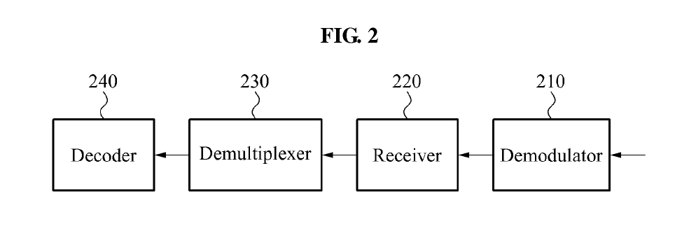

FIG. 2 is a block diagram illustrating a configuration of a reception terminal of an apparatus for bonding a broadcast channel according to an embodiment of the present invention.

Referring to FIG. 2, the reception terminal of the apparatus for bonding the broadcast channel may include a receiver 220 to receive TS packets via bonded channels and control packets including information associated with the TS packets via bonded channels and to rearrange the TS packets into a signal stream using the control packets, and a decoder 240 to decode the TS packets.

The reception terminal of the apparatus for bonding the broadcast channel may provide, to the receiver 220, the TS packets and the control packets transmitted from the transmission terminal to correspond to a format of the reception terminal by demodulating the TS packets and the control packets, using a demodulator 210.

The reception terminal of the apparatus for bonding the broadcast channel may provide, to the decoder 240, the TS packets and the control packets that are transmitted after being multiplexed to a transmission terminal, by demultiplexing the TS packets and the control packets, using a demultiplexer 230.

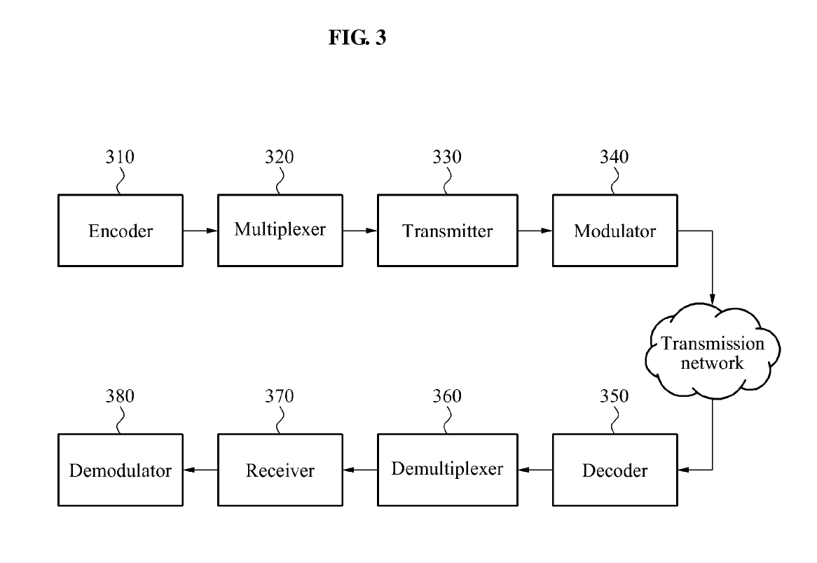

Hereinafter, a method of bonding a broadcast channel will be described based on an overall configuration of an apparatus for bonding a broadcast channel according to an embodiment of the present invention with reference to FIG. 3.

FIG. 3 is a block diagram illustrating an overall configuration of an apparatus for bonding a broadcast channel according to an embodiment of the present invention.

Referring to FIG. 3, the apparatus for bonding the broadcast channel may encode a mass broadcasting program such as a multi-view 3DTV and an UHDTV in an encoder 310 to output the mass broadcasting program in a form of TS packets.

According to an embodiment of the present invention, a multiplexer 320 may assign a virtual packet sequence information to the encoded TS packet.

The TS packets output from the encoder 310 may be multiplexed along with signaling information in the multiplexer 320 and output to a transmitter 330.

The transmitter 330 may determine a number of channels necessary and a transmission channel, based on an amount of data transmitted.

The transmitter 330 may include a channel distributer to determine the number of channels necessary and the transmission channel via which the TS packets is transmitted, based on an amount of data transmitted.

For example, the TS packets may be transmitted by being distributed via each bonded channel, and the transmitter 330 may distribute the TS packets via the each bonded channel, simultaneously transmitting control packets at a regular interval of transmitting the TS packets.

According to an embodiment of the present invention, the control packets may include information associated with the TS packets transmitted via the each bonded channel, and the information associated with the TS packets may include information associated with a packet generated or added by a different device or a different user aside from information of a number of TS packets, the virtual packet sequence information, and the like.

According to an embodiment of the present invention, the control packets may include information, for example, a number of TS packets transmitted between different control packets, the virtual packet sequence information of the TS packets, and the like, required for bonding and rearranging the TS packets transmitted via a plurality of broadcast channels in a reception terminal.

According to an embodiment of the present invention, the number of TS packets may include the number of TS packets associated with the control packets.

According to an embodiment of the present invention, the virtual packet sequence information may include a packet sequence number of virtually bonding with respect to the TS packets in a form of a single stream.

According to an embodiment of the present invention, the control packets may include information to bond and rearrange the TS packets transmitted via the each bonded channel.

Hereinafter, a method of bonding a broadcast channel will be described with reference to detailed embodiments in which broadcasting contents are transmitted according to an embodiment of the present invention.

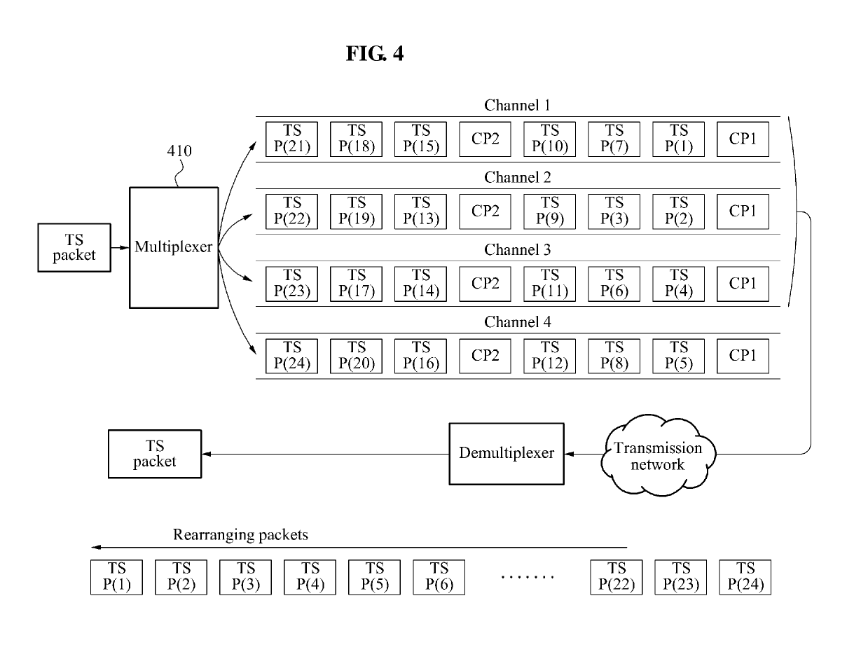

FIG. 4 is a diagram describing an example of transmission of broadcasting contents according to an embodiment of the present invention.

Referring to FIGS. 4 and 3, TS packets according to an embodiment of the present invention may be output in an encoder 310, multiplexed along with signaling information in a multiplexer 320, and input to a transmitter 330.

The transmitter 330 may determine a transmission channel via which a corresponding broadcasting program is transmitted, and distribute the input TS packets to each transmission channel.

For example, the transmitter 330 may be input by the TS packets input in a form of a single stream in a multiplexer 410, and assign virtual packet sequence information having a length of 2 bytes to the input TS packets.

According to an embodiment of the present invention, the virtual packet sequence number information may number a first packet among streams of a corresponding TS packet at a start point “1”, and subsequently tag remaining packets by increasing each number by an increment of “1” for each packet.

According to an embodiment of the present invention, the virtual packet sequence number information is a value used only in the transmitter 330 and a receiver 360 for transmitting and receiving of packets corresponding to an sequence, and may not be information additionally included in the TS packets during process of transmitting and decoding.

The TS packets according to an embodiment of the present invention may be provided in a form of an MPEG-2 TS packet.

According to an embodiment of the present invention, the transmitter 330 may distribute the TS packets to channels via which a corresponding program is transmitted, using the virtual packet sequence number information.

For example, the transmitter 330 may transmit control packets between the TS packets through each of the transmission channels via which the TS packets are transmitted, and the transmitted control packets may include information pertinent to a number of TS packets transmitted between different control packets and the virtual packet sequence number to information for each TS packet.

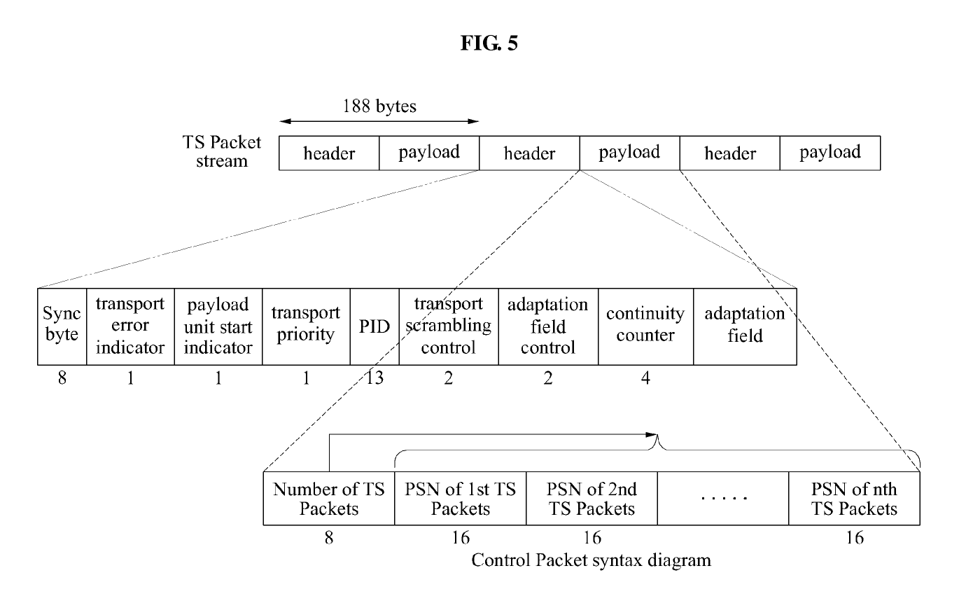

FIG. 5 is a diagram illustrating a structure of control packets according to an embodiment of the present invention.

Referring to FIG. 5, an overall structure of the control packets may be the structure of TS packets, and add an information field generated via a different apparatus apart from an apparatus for bonding a broadcast channel according to an aspect of the present invention.

According to an embodiment of the present invention, a structure of the control packets may be identical to the structure of the TS packets, and assign a packet identifier (PID) value for controlling the TS packets.

According to an embodiment of the present invention, the PID may designate and use a random value in an area that may be used by a user in an MPEG

According to an embodiment of the present invention, a payload included in the control packets may include transmission information associated with TS packets transmitted subsequent to transmission of the control packets, and the transmission information included in the payload of the control packets is as follows.

According to an embodiment of the present invention, a number of the TS packets may indicate the number of TS packets transmitted subsequent to transmission of a corresponding control packet, that is, the number of TS packets transmitted between the corresponding control packet and a next control packet.

According to an embodiment of the present invention, virtual packet sequence number information may indicate a virtual packet sequence number of the TS packets transmitted subsequent to transmission of the control packets, that is, a packet sequence number virtually tagged to the TS packets in a form of a single stream in a transmitter 330 of FIG. 3.

For example, the virtual packet sequence number information may display each of TS packet sequence numbers in 2 bytes, and when a value of a number of the TS packets is n, the n number of virtual packet sequence number values may be included in the payload.

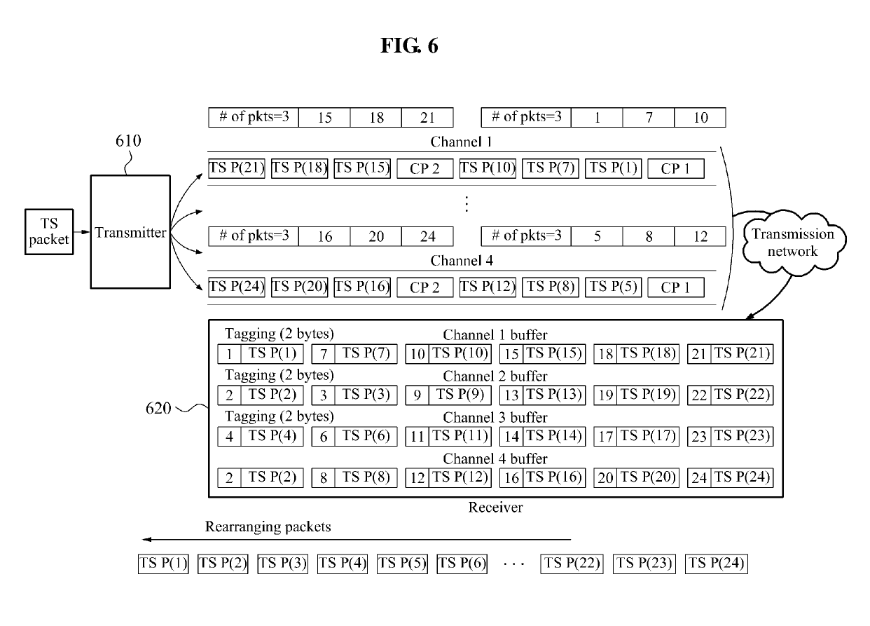

FIG. 6 is a diagram illustrating an operational process of transmitting and receiving, using control packets according to an embodiment of the present invention.

Referring to FIG. 6, in a case of an apparatus for bonding a broadcast channel according to an aspect of the present invention, a transmitter 610 that is located at a head end may assign virtual packet sequence number information with respect to TS packets that are input in a form of a single stream.

The apparatus for bonding the broadcast channel may distribute the TS packets to buffers of assigned transmission channels in order to transmit the TS packets of a corresponding program.

The apparatus for bonding the broadcast channel may generate control packets including information associated with a number of TS packets distributed to each of the assigned transmission channels and the virtual packet sequence number information.

The apparatus for bonding the broadcast channel may transmit the TS packets including information associated with a corresponding control packet subsequent to transmission of the corresponding control packet.

The apparatus for bonding the broadcast channel may receive the control packets that is received via each of the transmission channels, using a receiver 620 located in a reception terminal.

The apparatus for bonding the broadcast channel may extract information associated with the number of TS packets that arrive subsequent to reception of the control packets and the virtual packet sequence number information.

The apparatus for bonding the broadcast channels may rearrange the TS packets arriving subsequently, into the single stream, using a virtual packet identifier number, and output the bonded TS packets to a channel output buffer.

The receiver 620 of the apparatus for bonding the broadcast channel may output the TS packets in the form of the single stream to correspond to a packet sequence, using the virtual packet identifier number of the TS packets stored in each of the channel output buffer.

The apparatus for bonding the broadcast channel may output the TS packets from which tagging information added for an internal processing is deleted via the receiver 620, and the output TS packet may be decoded via a decoder.

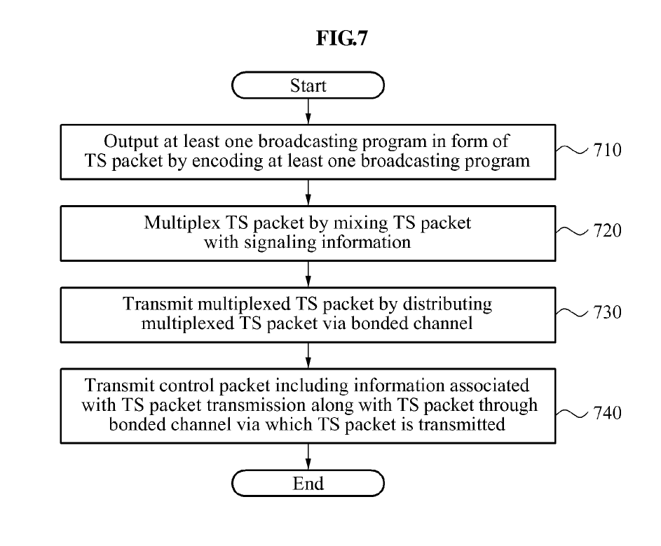

Hereinafter, a method of bonding a broadcast channel according to an embodiment of the present invention will be described from a perspective of a transmission terminal and a reception terminal with reference to FIG. 7.

FIG. 7 is a flowchart illustrating a method of bonding a broadcast channel, from a perspective of a transmission terminal of an apparatus for bonding a broadcast channel, according to an embodiment of the present invention.

Referring to FIG. 7, in operation 710, the apparatus for bonding the broadcast channel may output at least one broadcasting program in a form of TS packets by encoding the at least one broadcasting program.

In operation 720, the apparatus for bonding the broadcast channel may multiplex the TS packets by mixing the TS packets with signaling information.

In operation 730, the apparatus for bonding the broadcast channel may transmit the multiplexed TS packet by distributing the multiplexed TS packet via bonded channels.

In operation 740, the apparatus for bonding the broadcast channel may transmit control packets to control the TS packets along with the TS packets through the bonded channels via which the TS packets is transmitted.

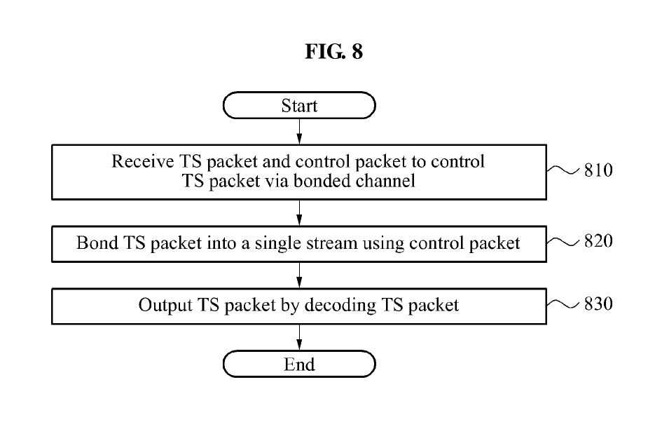

FIG. 8 is a flowchart illustrating method of bonding a broadcast channel, from a perspective of a reception terminal of an apparatus for bonding a broadcast channel, according to an embodiment of the present invention.

Referring to FIG. 8, in operation 810, the apparatus for bonding the broadcast channel may receive TS packets and control packets to control via bonded channels.

In operation 820, the apparatus for bonding the broadcast channel may rearrange the TS packets into a single stream, using the control packets.

In operation 830, the apparatus for bonding the broadcast channel may output the TS packets by decoding the TS packets.

According to embodiments of the present invention, it is enabled by an apparatus for bonding a broadcast channel to effectively embody bonding of the broadcast channel and provide at the same time a multi-view 3DTV and an UHDTV by transmitting control packets to a transmission channel at a regular interval so as to transmit a mass broadcasting program.

According to embodiments of the present invention, there is provided effective bonding of a broadcast channel by transmitting control packets to each transmission channel at a regular interval when transmitting a mass broadcasting program including a multi-view 3DTV, an UHDTV, and the like through bonding of the broadcast channel.

According to embodiments of the present invention, it is possible to determine which packet is lost when a loss of TS packets occurs during transmission of broadcasting contents, and facilitate rearranging of the TS packets in a reception terminal.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for bonding a broadcast channel, the apparatus comprising:
an encoder to output at least one broadcasting program by encoding the at least one broadcasting program to a transport stream packet (TS packet);
a multiplexer to multiplex the TS packets by mixing the TS packets with signaling information; and
a transmitter to transmit the multiplexed TS packet via bonded channels,
wherein the transmitter transmits control packets, along with the TS packets, comprising information associated with the TS packets transmission through the bonded channels via which the TS packets is transmitted.

2. The apparatus of claim 1, wherein the transmitter comprises:
a channel distributer to determine a number of channels and a transmission channel via which the TS packets is transmitted, based on an amount of data transmitted.

3. The apparatus of claim 1, wherein the control packets comprises information associated with the TS packets that is transmitted via each of the determined number of channels and the transmission channel.

4. The apparatus of claim 3, wherein the information associated with the TS packets comprises a number of TS packets, and
the number of TS packets comprises a number of packets associated with the control packets.

5. The apparatus of claim 3, wherein the information associated with the TS packets comprises virtual packet sequence information, and
the virtual packet sequence information comprises a packet sequence number that is tagged virtually, in a form of a single stream, with respect to the TS packets.

6. The apparatus of claim 1, wherein the control packets comprises information to bond and rearrange the TS packets that is transmitted via the bonded channels.

7. The apparatus of claim 1, wherein the control packets is provided in a structure identical to a structure of the TS packets, and assigns a packet identifier (PID) value to control the TS packets.

8. The apparatus of claim 1, wherein the multiplexer assigns the virtual packet sequence information to the encoded TS packet.

9. The apparatus of claim 1, further comprising:
a modulator to modulate and transmit the TS packets and the control packets that are transmitted to correspond to a form of a receiving terminal.

10. An apparatus for bonding a broadcast channel, the apparatus comprising:
a receiver to receive TS packets and control packets comprising information associated with the TS packets transmitted via bonded channels, and rearrange the TS packets to a single stream using the control packets; and
a decoder to decode the TS packets.

11. The apparatus of claim 10, wherein the control packets comprises information associated with the TS packets transmitted via the bonded channels.

12. The apparatus of claim 10, wherein the control packets comprises information for bonding and rearranging the TS packets transmitted via the bonded channels.

13. A method of bonding a broadcast channel, the method comprising:
outputting at least one broadcasting program by encoding the at least one broadcasting program to TS packets;
multiplexing the TS packets by mixing the TS packets with signaling information;
transmitting the multiplexed TS packet by distributing the multiplexed TS packet via bonded channels; and
transmitting control packets, along with the TS packets, comprising information associated with the TS packets through the bonded channels via which the TS packets is transmitted.

14. The method of claim 13, wherein transmitting the multiplexed TS packet by distributing the multiplexed TS packet via bonded channels comprises determining a number of channels and a transmission channel via which the TS packets is transmitted, based on an amount of data transmitted.

15. The method of claim 13, wherein the control packets comprises information associated with the TS packets transmitted to each of the determined number of channels and the transmission channel.

16. The method of claim 13, wherein the control packets comprises information for bonding and rearranging the TS packets transmitted via the bonded channels.

17. The method of claim 13, wherein the multiplexing of the TS packets comprises:
assigning virtual packet sequence information to the encoded TS packet.

18. The method of claim 13, further comprising:
modulating and transmitting the transmitted TS packet and the control packets to correspond to a form of a receiving terminal.

19. A method of bonding a broadcast channel, the method comprising:
receiving TS packets and control packets to control the TS packets via bonded channels;
rearranging the TS packets to a single stream using the control packets; and
decoding the TS packets.
